(19) United States
(12) Patent Application Publication
(10) Pub. No.: US 2003/0233563 A1
(43) Pub. Date: Dec. 18, 2003

(54) Method and system for securely transmitting and distributing information and for producing a physical instantiation of the transmitted information in an intermediate, information-storage medium

(76) Inventor: Sky Kruse, Seattle, WA (US)

Correspondence Address: Robert W. Bergstrom, OLYMPIC PATENT WORKS, PLLC, P.O. Box 4277, Seattle, WA, 98104, US

(21) Appl. No.: 10/351,270

(22) Filed: Jan. 23, 2003

Related U.S. Application Data
(60) Provisional application No. 60/352,475, filed on Jan. 23, 2002.

(51) Int. Cl. G06F 12/14

(52) U.S. Cl. 713/193

(57) ABSTRACT

A method and system for securing retrieval of content, and transcription of the retrieved content to a physical medium in a form not readily susceptible to interception. Encrypted and compressed content is retrieved from a series of servers, via the Internet or other communications pathway, by a consumer. Once the content is present in local storage, or is accessible through a high-rate-of-transfer medium, client-side software running on the consumer's computer or other appliance coordinates with one or more servers to decompress and re-encrypt the content into memory of the consumer's computer or other appliance, and then to decrypt and transfer, a portion at a time, the content from the memory of the consumer's computer or other appliance to a writeable CD within a CD drive of the consumer's computer or other computing appliance, producing a final information-containing CD. During this process, only a small portion of the content appears in decompressed and fully decrypted form within the memory of the consumer's computer or other electronic device. Otherwise, the content is compressed and well protected by one or more layers of encryption.

### CROSS-REFERENCE TO RELATED APPLICATION

This application claims the benefit of Provisional Patent Application No. 60/352,475, filed Jan. 23, 2002, incorporated herein by reference.

### COMPUTER PROGRAM LISTING APPENDIX

Two identical CDs identified as “Copy 1” and “Copy 2,” containing program source code implementing an embodiment of the present invention, are included as a computer program listing appendix. The program can be displayed, compiled, and executed using Microsoft Visual C++, version 6.0, running on Windows 2000 or Windows XP operating systems. Each disk contains the following directories and files:

Directory of lcd-code

| File Name | File Size | Date/Time Created |
|---|---|---|
| dir aacdec | | |
| dir cppunit | | |
| dir Debug | | |
| dir Header | | |
| LCD.dsp | 16,144 bytes | Jan. 16, 2003 12:00 AM |
| LCD.dsw | 810 bytes | Mar. 03, 2002 12:05 PM |
| LCD.rc | 28,109 bytes | Dec. 04, 2002 1:13 AM |
| LCD.reg | 737 bytes | Jun. 12, 2002 11:29 PM |
| dir lcdeng | | |
| dir lib | | |
| Logon.wav | 486,188 bytes | Feb. 09, 2002 12:34 AM |
| MakeHelp.bat | 1,330 bytes | Jun. 12, 2002 11:29 AM |
| dir mpglib | | |
| dir Release | | |
| dir Res | | |
| resource.h | 8,086 bytes | Dec. 04, 2002 1:13 AM |
| dir Source | | |
| dir unitTests | | |
| Files: | | |
| LCD.dsp | | |
| LCD.dsw | | |
| LCD.rc | | |
| LCD.reg | | |
| Logon.wav | | |
| MakeHelp.bat | | |
| resource.h | | |
| dir aacdec | | |
| aaclib.h | 278 bytes | Jun. 22, 2002 5:23 PM |
| dir cppunit | | |
| | 0 bytes | Jan. 23, 2003 2:39 PM |
| dir cppunit\include | | |
| Makefile.am | 87 bytes | Feb. 09, 2002 12:34 AM |
| Makefile.in | 10,537 bytes | Feb. 09, 2002 12:34 AM |
| dir msvc6 | | |
| dir cppunit\include\cppunit | | |
| config-bcb5.h | 1,229 bytes | Jan. 09, 2002 12:34 AM |
| config-msvc6.h | 1,266 bytes | Feb. 09, 2002 12:34 AM |
| Exception.h | 1,513 bytes | Feb. 09, 2002 12:34 AM |
| dir extensions | | |
| Makefile.am | 485 bytes | Feb. 09, 2002 12:34 AM |
| Makefile.in | 12,131 bytes | Feb. 09, 2002 12:34 AM |
| NotEqualException.h | 1,024 bytes | Feb. 09, 2002 12:34 AM |
| dir lcd-patent-filelist.txt | | |
| Portability.h | 1,866 byte | Feb. 09, 2002 12:34 AM |
| Test.h | 1,685 byte | Feb. 09, 2002 12:34 AM |
| TestAssert.h | 4,095 byte | Feb. 09, 2002 12:34 AM |
| TestCaller.h | 4,607 byte | Feb. 09, 2002 12:34 AM |
| TestCase.h | 3,452 byte | Feb. 09, 2002 12:34 AM |
| TestFailure.h | 1,106 byte | Feb. 09, 2002 12:34 AM |
| TestListener.h | 563 byte | Feb. 09, 2002 12:34 AM |
| TestRegistry.h | 1,016 byte | Feb. 09, 2002 12:34 AM |
| TestResult.h | 3,443 byte | Feb. 09, 2002 12:34 AM |
| TestSuite.h | 1,545 byte | Feb. 09, 2002 12:34 AM |
| TextTestResult.h | 907 byte | Feb. 09, 2002 12:34 AM |
| TextTestRunner.h | 1,126 byte | Feb. 09, 2002 12:34 AM |
| dir cppunit\include\cppunit\ | | |
| extensions | | |
| AutoRegisterSuite.h | 1,417 bytes | Feb. 09, 2002 12:34 AM |
| HelperMacros.h | 9,060 bytes | Feb. 09, 2002 12:34 AM |
| Makefile.am | 314 bytes | Feb. 09, 2002 12:34 AM |
| Makefile.in | 8,419 bytes | Feb. 09, 2002 12:34 AM |
| Orthodox.h | 2,256 bytes | Feb. 09, 2002 12:34 AM |
| RepeatedTest.h | 831 bytes | Feb. 09, 2002 12:34 AM |
| TestDecorator.h | 1,425 bytes | Feb. 09, 2002 12:34 AM |
| TestFactory.h | 438 bytes | Feb. 09, 2002 12:34 AM |
| TestFactoryRegistry.h | 2,263 bytes | Feb. 09, 2002 12:34 AM |
| TestSetUp.h | 704 bytes | Feb. 09, 2002 12:34 AM |
| TestSuiteBuilder.h | 2,069 bytes | Feb. 09, 2002 12:34 AM |
| TestSuiteFactory.h | 449 bytes | Feb. 09, 2002 12:34 AM |
| TypeInfoHelper.h | 727 bytes | Feb. 09, 2002 12:34 AM |
| dir cppunit\include\msvc6 | | |
| | 0 bytes | Jan. 23, 2003 2:39PM |
| dir DSPlugin | | |
| dir testrunner | | |
| dir cppunit\include\msvc6\ | | |
| DSPlugin | | |
| TestRunnerDSPlugin.h | 5,575 bytes | Feb. 09, 2002 12:34 AM |
| TestRunnerDSPlugin_i.c | 2,073 bytes | Feb. 09, 2002 12:34 AM |
| dir cppunit\include\msvc6\ | | |
| testrunner | | |
| TestPlugInInterface.h | 496 bytes | Feb. 09, 2002 12:34 AM |
| TestRunner.h | 1,447 bytes | Feb. 09, 2002 12:34 AM |
| dir Debug | | |
| | 0 bytes | Jan. 23, 2003 2:39 PM |
| dir Header | | |
| AlbumDetails.h | 1,365 bytes | Jan. 06, 2003 2:39 PM |
| BurnThread.h | 831 bytes | Aug. 19, 2002 8:55 PM |
| cdbar.h | 1,704 bytes | Jun. 12, 2002 11:20 PM |
| ContentDescription.h | 2,756 bytes | Jan. 23, 2003 1:58 PM |
| ConvertThread.h | 1,349 bytes | Oct. 09, 2002 10:46 PM |
| DDC.H | 1,539 bytes | Dec. 07, 2001 1:24 AM |
| DiscBar.h | 1,660 bytes | Jun. 23, 2002 7:35 PM |
| DiscListCtrl.h | 1,791 bytes | Aug. 17, 2002 9:18 PM |
| Drvedialog.h | 1,715 bytes | Oct. 13, 2002 5:07 PM |
| HttpFile.h | 1,420 bytes | Oct. 09, 2002 10:46 PM |
| InitDialogBar.h | 2,006 bytes | Jun. 12, 2002 11:29 PM |
| killconversiondlg.h | 1,386 bytes | Oct. 09, 2002 10:46 PM |
| Label.h | 3,434 bytes | Aug. 25, 2002 7:07 PM |
| labelpreview.h | 1,393 bytes | Dec. 04, 2002 1:13 AM |
| LabelPrinter.h | 1,392 bytes | Jan. 06, 2003 12:28 AM |
| LCD.h | 4,531 bytes | Oct. 11, 2002 4:36 PM |
| ListBoxST.h | 4,318 bytes | Sep. 03, 2002 4:18 PM |
| mainframe.h | 4,973 bytes | Dec. 03, 2002 3:13 AM |
| md5.h | 2,970 bytes | Jun. 11, 2002 12:23 AM |
| MemDC.h | 2,836 bytes | Jun. 22, 2002 5:27 PM |
| msxml.tlh | 59,584 bytes | Nov. 29, 2001 11:43 PM |
| msxml.tli | 54,054 bytes | Nov. 29, 2001 11:43 PM |
| multithread.h | 2,077 bytes | Oct. 12, 2002 6:03 PM |
| PictureDialog.h | 1,458 bytes | Feb. 21, 2002 9:47 PM |
| propertyrecord.h | 1,455 bytes | Aug. 19, 2002 8:55 PM |
| propertytemp.h | 1,450 bytes | Jun. 28, 2002 10:10 PM |
| queuebar.h | 1,427 bytes | Aug. 19, 2002 10:09 PM |
| RecordAudio.h | 427 bytes | May 31, 2002 9:04 PM |
| RIFF.H | 6,662 bytes | May 30, 2002 2:53 AM |
| SampleRateConverter.h | 1,811 bytes | Jun. 22, 2002 5:26 PM |
| Splasher.h | 2,053 bytes | Aug. 17, 2002 9:18 PM |
| StatusDlgBar.h | 2,273 bytes | Oct. 12, 2002 6:03 PM |
| StdAfx.h | 2,833 bytes | Oct. 12, 2002 6:03 PM |
| TaskQueue.h | 1,194 bytes | Oct. 11, 2002 4:35 PM |
| tempdrv.h | 395 bytes | Jun. 22, 2002 5:26 PM |
| TimeRemaining.h | 1,850 bytes | Oct. 12, 2002 6:03 PM |
| TKAppAudio.h | 641 bytes | May 31, 2002 9:04 PM |
| tkapplogdlg.h | 1,546 bytes | Jun. 08, 2002 10:51 PM |
| TKAppUserDlg.h | 2,755 bytes | Oct. 04, 2002 3:13 PM |
| TKInterface.h | 2,655 bytes | May 31, 2002 9:04 PM |
| TKUI.h | 0 bytes | May 31, 2002 9:04 PM |
| Track.h | 3,194 bytes | Nov. 04, 2002 12:08 AM |
| TrackDecode.h | 1,104 bytes | Apr. 17, 2002 9:47 PM |
| twofish.h | 577 bytes | May 30, 2002 2:53 AM |
| UIOptions.h | 518 bytes | Oct. 13, 2002 12:31 PM |
| waitdialog.h | 1,258 bytes | Oct. 13, 2002 5:07 PM |
| XComboList.h | 2,669 bytes | Jun. 22, 2002 5:26 PM |
| XHeaderCtrl.h | 2,773 bytes | Jun. 22, 2002 5:26 PM |
| XListCtrl.h | 8,609 bytes | Oct. 09, 2002 10:46 PM |
| dir lcdeng | | |
| lcdeng.dsp | 3,622 bytes | Apr. 24, 2002 10:28 PM |
| dir Release | | |
| LCD.res | 1,160,908 bytes | Jan. 08, 2003 2:31 PM |
| dir lib | | |
| cpunit.lib | 254,818 bytes | Feb. 09, 2002 12:34 AM |
| testrunner.dll | 65,536 bytes | Feb. 09, 2002 12:34 AM |
| testrunner.exp | 13,812 bytes | Feb. 09, 2002 12:34 AM |
| testrunner.lib | 23,822 bytes | Feb. 09, 2002 12:34 AM |
| testrunnerd.dll | 192,588 bytes | Feb. 09, 2002 12:34 AM |
| testrunnerd.lib | 23,880 bytes | Feb. 09, 2002 12:34 AM |
| TestRunnerDSPlugIn.dll | 36,864 bytes | Feb. 09, 2002 12:34 AM |
| dir mpglib | | |
| mp3lib.h | 258 bytes | Jun. 22, 2002 5:23 PM |
| dir Release | | |
| | 0 bytes | Jan. 23, 2003 2:39 PM |
| dir Res | | |
| checkboxes.bmp | 1,846 bytes | Jun. 22, 2002 5:27 PM |
| ContentDescription.ico | 1,078 bytes | Jun. 12, 2002 11:29 PM |
| latestlogo.bmp | 280,742 bytes | Jun. 09, 2002 9:41 PM |
| LCD.ico | 1,078 bytes | May 19, 2002 5:57 PM |
| LCD.rc2 | 395 bytes | Nov. 29, 2001 3:08 PM |
| lcdlogo.bmp | 802,054 bytes | May 19, 2002 5:57 PM |
| dir Source | | |
| AlbumDetails.cpp | 3,056 bytes | Jan. 06, 2003 12:28 AM |
| BurnThread.cpp | 2,357 bytes | Oct. 09, 2003 10:46 PM |
| CDBar.cpp | 12,046 bytes | Jun. 12, 2002 11:29 PM |
| ContentDescription.cpp | 21,847 bytes | Jan. 23, 2003 2:01 PM |
| ConvertThread.cpp | 2,701 bytes | Oct. 09, 2002 10:46 PM |
| Cookie.cpp | 18,639 bytes | Jun. 22, 2002 5:26 PM |
| CookieManager.cpp | 8,094 bytes | Mar. 03, 2002 12:19 PM |
| CookieUtil.cpp | 1,130 bytes | Mar. 03, 2002 12:19 PM |
| DDCRET.CPP | 1,091 bytes | Nov. 29, 2001 11:42 PM |
| DiscBar.cpp | 1,823 bytes | Oct. 09, 2002 10:46 PM |
| DiseListCtrl.cpp | 5,330 bytes | Sep. 03, 2002 4:18 PM |
| Drive.cpp | 13,747 bytes | Mar. 03, 2002 12:19 PM |
| drivedialog.cpp | 6,301 bytes | Oct. 13, 2002 5:07 PM |
| fftsg_fl.cpp | 72,743 bytes | Feb. 09, 2002 12:34 AM |
| HttpFile.cpp | 14,053 bytes | Nov. 05, 2002 11:29 AM |
| InitDialogBar.cpp | 2,700 bytes | Jun. 12, 2002 4:36 PM |
| killconversiondlg.cpp | 4,060 bytes | Oct. 11, 2002 4:36 PM |
| Label.cpp | 30,974 bytes | Aug. 25, 2002 7:07 PM |
| labelpreview.cpp | 1,086 bytes | Dec. 04, 2002 1:13 AM |
| LabelPrinter.cpp | 17,478 bytes | Jan. 08, 2003 3:33 PM |
| LCD.cpp | 27,747 bytes | Oct. 16, 2002 8:46 AM |
| ListBoxST.cpp | 24,614 bytes | Sep. 03, 2002 4:18 PM |
| mainframe.cpp | 28,042 bytes | Dec. 04, 2002 1:13 AM |
| md5.cpp | 15,139 bytes | Aug. 21, 2002 8:53 PM |
| multithread.cpp | 2,468 bytes | Oct. 11, 2002 4:36 PM |
| PictureDialog.cpp | 4,112 bytes | Mar. 13, 2002 2:08 AM |
| Property Record.cpp | 2,271 bytes | Aug. 19, 2002 8:55 PM |
| propertytemp.cpp | 4,899 bytes | Aug. 17, 2002 9:18 PM |
| queuebar.cpp | 1,609 bytes | Aug. 19, 2002 10:09 PM |
| RecordAudio.cpp | 6,110 bytes | Jun. 22, 2002 5:26 PM |
| RIFF.CPP | 23,025 bytes | May 30, 2002 2:53 AM |
| SampleRateConverter.cpp | 78,654 bytes | Jun. 22, 2002 5:26 PM |
| Splasher.cpp | 9,458 bytes | Aug. 17, 2002 9:18 PM |
| StatusDlgBar.cpp | 4,834 bytes | Oct. 13, 2002 1:57 PM |
| StdAfx.cpp | 205 bytes | Nov. 29, 2001 3:08 PM |
| TaskQueue.cpp | 4,385 bytes | Jan. 23, 2003 1:57 PM |
| tempdrv.cpp | 2,899 bytes | Oct. 02, 2002 8:30 AM |
| TimeRemaining.cpp | 5,275 bytes | Oct. 12, 2002 6:03 PM |
| TKAppAudio.cpp | 9,848 bytes | May 31, 2002 9:04 PM |
| tkapplogdlg.cpp | 9,162 bytes | Jun. 07, 2002 9:46 PM |
| TKAppUserDlg.cp | 21,356 bytes | Oct. 02, 2002 8:31 AM |
| TKInterface.cpp | 11,384 bytes | Aug. 17, 2002 9:18 PM |
| TKUI.cpp | 8,674 bytes | Oct. 09, 2002 10:46 PM |
| Track.cpp | 11,384 bytes | Nov. 04, 2002 12:08 AM |
| TrackDecode.cpp | 2,889 bytes | Apr. 17, 2002 9:47 PM |
| twofish.cpp | 4,255 bytes | Mar. 09, 2002 3:11 PM |
| UIOptions.cpp | 549 bytes | Oct. 13, 2002 12:31 PM |
| waitdialog.cpp | 1,403 bytes | Oct. 13, 2002 5:07 PM |
| XComboList.cpp | 9,995 bytes | Jun. 22, 2002 5:26 PM |
| XHeaderCtrl.cpp | 10,619 bytes | Jun. 22, 2002 5:26 PM |
| XListCtrl.cpp | 58,477 bytes | Oct. 09, 2002 10:46 PM |

### TECHNICAL FIELD

The present invention relates to the distribution of information, such as digital, audio, and video media, software object code, textual media, including source code for software programs, and other such information and, in particular, to a method and system for securely distributing the information via communications media and a personal computer to a physical, information-storing intermediate medium, such as an audio CD, a DVD, and a software-containing CD-ROM, without exposing the transferred information to security risks present in, and associated with, untrusted devices and communications media.

### BACKGROUND OF THE INVENTION

The present invention concerns transmission of digitally encoded information to consumers for storage on removable, physical information-storage media. The present invention employs cryptographic methodologies in order to secure communications between servers and client computers, and a basic background for cryptographic techniques is provided, below, in a first subsection. A general background for the present invention is provided in a second subsection.

### Cryptography Background

The present invention employs cryptographic methodologies in order to secure communications between an administrative console, or host, and remote agents. In this subsection, the basic cryptographic methods employed are described in general terms. Cryptography is designed to transform plain text information into encoded information that cannot be easily decoded by unauthorized entities. For example, a plain text message may include an English-language sentence. This plain text message can be encrypted by any of various encryption functions E into a corresponding cipher text message that is not readily interpretable. An authorized user is provided with a decryption function D that allows the authorized user to decrypt the cipher text message back to the original plain text message.

The basic cryptographic methods can be described using the following definitions:

$$\begin{matrix}{A}_{m} = alphabet for messages = \{ {a}_{{m}_{1}} , {a}_{{m}_{2}} , {a}_{{m}_{3}} … {a}_{{m}_{n}} \} \\ {A}_{c} = alphabet for cipher - text = \{ {a}_{{c}_{1}} , {a}_{{c}_{2}} , {a}_{{c}_{3}} … {a}_{{c}_{n}} \} \\ M = message - space = strings of {a}_{m} \\ C = cipher - text space = strings of {a}_{c} \\ K = key space = \{ {e}_{1} , {e}_{2} … {e}_{n} \} where {E}_{{e}_{i}} ( m ) -> c \\ = \{ {d}_{1} , {d}_{2} … {d}_{n} \} where {D}_{{d}_{i}} ( d ) -> m\end{matrix}$$

Plain text messages are instances of messages contained within the message space M and cipher text messages are instances of the cipher text messages contained within cipher test space C. A plain text message comprises a string of one or more characters selected from a message alphabet Aₘ, while a cipher-text message comprises a string of one or more characters selected from the cipher-text alphabet A_{c}. Each encryption function E employs a key e and each decryption function D employ a key d, where the keys e and d are selected from a key space K.

A key pair is defined as follows:

key pair=(e, d)

where eεK, dεK,D_{d}(Eₑ(m))=m, and mεM

One key of the key pair, e, is used during encryption to encrypt a message to cipher text via an encryption function E, and the other key of the key pair, d, can be used to regenerate the plain text message from the cipher-text message via a decryption function D.

Public-key cryptographic methods are encryption/decryption techniques employing key pairs (e,d) having the property that, for all key pairs (e,d), no function f(e)=d can be easily determined. Thus, the encryption key e of a public-key pair (e,d) can be freely distributed, because the corresponding decryption key d of the public-key pair cannot be determined from the encryption key e. A well-known example of public-key encryption is the RSA encryption scheme. The RSA scheme employs integer division of large numbers, generated from plain text and cipher-text messages, by large integers n that represent the product of two prime numbers p and q as follows:

E(m)=m^{e}mod n

D(c)=c^{d} mod n

ed mod (p−1)(q−1)=1

n=pq

Thus, a plain text message is encrypted by considering all of the numeric representations of the characters of the message to be a large number, computing the result of raising the large number to a power equal to the encryption key e, dividing that result by n, and using the remainder of the division as the encrypted message. Decryption employs the same process, raising the cipher-text message to a power equal to the decryption key d, then regenerating the plain text message by considering the remainder, followed by division by n, as a string of numerically represented characters.

A digital signature is a value generated from a message that can be used to authenticate the message. The digital signature space S contains all possible digital signatures for a particular digital signature algorithm applied to messages selected from message space M. Generation of a digital signature involves a secretly held digital signature generation function S_{A} applied to a message:

S_{A}(m)→s

The digital signature s is sent, along with the message m from which the digital signature is generated, to a recipient. The recipient employs a public verification function V_{A} to determine whether the digital signature authenticates the message or, in other words, whether the message was composed by the signer, and has not been modified in the interim. Thus, V_{A} can be expressed, as follows:

V_{A}(m, s)→{true, false}

where the result true indicates that the message m was composed by the signer who provided the digital signature s.

A digital-signature system can be generated from a reversible public-key encryption system, defined as follows:

for all m, D_{d}(Eₑ(m))=Eₑ(D_{d}(m))

where the message space, M=the cipher space, C=the digital signature space, S. The digital-signature-generating function S_{A} can be selected as:

S_{A}=D_{d}

so that:

S=D_{d}(m)

The verification function V_{A} can then be selected as:

$${V}_{A} ( m , s ) = \{ \begin{matrix}true , if {E}_{e} ( s ) = m \\ false \end{matrix}$$

Thus, the techniques of the public key encryption technique can be used to generate digital signatures that can, in turn, be used by a digitally signed message recipient, to verify that a message was sent by the party supplying the digital signature.

While it is generally feasible to digitally sign entire, short email messages, it is rather inefficient to digitally sign large amounts of data, such as an executable image. A more efficient way to digitally sign a large amount of data, such as an executable image, is to first digitally hash the large amount of data to a hash value, and then digitally sign the hash value. An efficient hashing function is required that produces a relatively small hash value from a large amount of data in a way that generates large distances in hash-value space between hash values generated from data inputs relatively close together in data-input space. In other words, small changes to input data should widely disperse generated hash values in hash-value space, so that the hash function cannot be deduced systematically. One example of a hash function widely used for this purpose is the Secure Hash Algorithm (“SHA-1”) specified by the Secure Hash Standard, available at the web site specified by the URL: http://www.itl.nist.gov/fipspubs/fip180-1.htm. The SHA-1 secure hash algorithm generates a 160-bit hash value, called a message digest, from a data file of any length less than 2⁶⁴ bits in length. The SHA-1 algorithm is a secure hash because it is computationally infeasible to find a message which corresponds to a given message digest, or to find two different messages which produce the same message digest.

In symmetric key encryption, both the sender and receiver of encrypted messages employ the same secret key. For example, if the secret key were the word “applesauce”, the equations would be:

Cipher-text=Encrypt(Clear-text, “applesauce”)

Clear-text=Decrypt(Cipher-text, “applesauce”)

Keys normally used are long, randomized bit strings. The lengths of keys are determined by the specific symmetric cipher. The binary values of keys are generated by processes that are constructed to insure that the values are sufficiently unpredictable.

Symmetric ciphers are of two basic types: (1) block ciphers; and (2) stream ciphers. A block cipher encrypts or decrypts a single, fixed-size block at a time. The size of a block is defined by the specific block cipher. A streaming cipher generates a sequence of binary values that are XORed with the Clear-text to encrypt, or with the Cipher-text to decrypt. The size of each binary value generated by a stream cipher is defined by the specific stream cipher.

Symmetric key encryption executes at high speed. On grounds of security and performance, symmetric ciphers rank very highly. For any confidential, high-volume data interchange, symmetric key cryptography is the preferred choice, because of its high performance.

### General Background

For the past 100 years, enormous scientific, technical, and commercial effort has been devoted to developing and improving methods and systems for the exchange of information via communications media. Many of the earliest communications media continue to provide for the exchange of extremely large volumes of information. These communications media include telephone communications, radio broadcasts, and television broadcasts. By contrast, many older forms of physical information storage, such as phonograph records, have been largely supplanted by newer information storage media, including compact disks (“CDs”). Similarly, older floppy disk drives have been largely supplanted by more modem CD-ROM disks.

The migration from analog transmission and storage of information to digital transmission and storage of information represents a fundamental improvement over older, analog communications media, and digital storage and transmission of information is a principal foundation for newer types of communications media. Digital information transmission and storage has many advantages. One of the greatest advantages of digital information transmission and storage is that information can be far more reliably transmitted, stored, and copied, without the serious information degradation and loss attendant with transmission and reproduction of analog data. Another advantage of digital information storage is that the fundamental units of digital information are common to all types of digital physical media and digital-information-display-and-presentation devices. For example, digital information encoded in a stream of bytes transferred via the Internet can be easily encoded into any number of different physical digital information-storage media for subsequent presentation and display on many different types of information-presentation-and-display devices. By contrast, the information stored in an analog vinyl phonograph record can be reliably and economically accessed only via a phonograph needle embedded within a phonograph device.

The Internet has become a popular means for distributing virtually any sort of digitally encoded information. The advent of Napster, Gnutella, and other peer-to-peer file sharing systems, in combination with high quality audio-compression tools and relatively large bandwidth, have made it easy for individuals to trade music. These distribution systems have created great controversy and concern for traditional music distributors, including manufacturers of CDs, music broadcasters, and musicians. Other advances in computer technology have made it readily feasible and affordable for personal computers to be equipped with CD writers that allow for storing large amounts of digitally encoded information on various types of CDs, including CD-Rs that can be written once, and CD-RWs that can be repeatedly rewritten. These devices are also often equipped with software for writing out audio CDs. There are a variety of audio CD formats currently used, with Red Book Audio, supported by a wide variety of CD players, considered to be an important standard format.

The combination of these technical advances has made it feasible for reasonably technology-aware end users to download music illegally and create an audio CD for which no compensation is paid to artists and/or copyright holders. The illegally created audio CD may be of relatively limited quality, as compared to the original CD, and the illegal copier bears the risks that accompany copyright infringement, but, because music files can be obtained without paying fees, illegal music downloading is currently a popular method for obtaining music. Similarly, the advent of DVD writing appliances, faster computers, and faster Internet connectivity has made it feasible for video content to be illegally downloaded and accessed, including downloading of music videos, television programs, movies, and other similar media. Software piracy has been endemic for decades, at least since the appearance of personal computers. Similar problems can be anticipated to plague any type of digital content exchanged by communications media and/or physical information-storage media.

Due to the ease of illegal distribution of content as the result of the above-noted advances in technology, the music industry has been reluctant to adopt a sales strategy that utilizes the Internet as a means for direct content distribution. Personal computers are increasingly inexpensive and increasingly capable duplicators and/or transmitters of digitally encoded information. The ease by which digitally encoded information can be reproduced on personal computers provides unscrupulous individuals with the ability to massively reproduce content and distribute the reproduced content without returning revenue to the original content provider.

Any number of proposals have been made for locking content for access only on a particular computer. The intent behind most of these proposals is to restrict access to content and restrict the manner by which content is used. However, these proposals ignore the fact that, ultimately, customers wish to listen to music, watch movies, and otherwise enjoy content in a manner of their choosing, rather than being restricted to doing so exclusively on their desktop computers. For example, consumers generally play music on a stereo, boom box, or car-mounted CD player. Likewise, video is typically played on a television. Therefore, many of these schemes and proposals for locking content for access on a particular computer do not result in commercially feasible content access methods for consumers.

Although physical CDs and DVDs remain a popular medium on which digitally encoded information is obtained by consumers, producers of audio CDs have noticed a rather steep decline in CD sales during the past few years as a result of illegal copying and transmission of recorded music via the Internet and personal computers. Moreover, the current methods by which CDs and DVDs are distributed are labor intensive and energy intensive, leading to relatively high costs in comparison to digital transmission of information. Consider, for example, FIG. 1, in which various stages in the path from recording music to obtaining the recorded music by a consumer are illustrated. As shown in FIG. 1, music is normally recorded at a recording studio 101 onto a physical medium, and then transferred by automobile 102 or truck to a corporate site 103 where the recorded music may be further edited, compiled, and packaged for production. The packaged recorded music is then transferred physically to a manufacturing facility 104 where, in the case of audio CDs, the packaged recorded music is used to produce masters, which are, in turn, used to stamp thousands or millions of copies of the recorded music onto individual CDs. These CDs are then trucked 105 to various distribution facilities 106, from which they are again trucked 107 to various retail outlets 108. In order to acquire CDs, a consumer generally drives by automobile 109 or public transportation to a retail outlet 108, searches through racks of CDs, purchases the CDs, and then returns by automobile or public transportation to the consumer's house. 110. In the past few years, alternatives to certain of these pathways have arisen. For example, a consumer may now shop for, and order CDs via the Internet. The CDs are delivered to the consumer by mail. Thus, the retail outlet 108 is removed from the pathway when consumers shop for CDs via the Internet. However, despite such improvements, the production and distribution of CDs remains relatively labor intensive and energy consumptive. For these reasons, information and content creators, providers, and distributors have recognized the need for reliably and securely transmitting information and content to consumers in a less labor-intensive and more energy-efficient manner, and in a manner that prevents malicious individuals and groups from illegally reproducing and selling the content.

### SUMMARY OF THE INVENTION

One embodiment of the present invention provides a method and system for securing retrieval of content and for transcription of the retrieved content to a physical medium in a form not readily susceptible to interception. Encrypted and compressed content is retrieved from a series of servers, via the Internet, private networks, other communications media, or from information-storage media by a consumer. When the rate of transfer of the content is limiting, the content may be first locally stored on a consumer's computer, another data-processing appliance, or a commercial kiosk, to facilitate rapid processing during subsequent steps. Once the content is present in local storage, or is accessible through a high-rate-of-transfer medium, client-side software running consumer's computer, another data-processing appliance, or a commercial kiosk coordinates with one or more servers to decompress, re-encrypt, and temporarily store the content into the volatile memory of the consumer's computer or other data-processing appliance, and to then decrypt and transfer the content from the memory of the consumer's computer or other appliance to a CD-R, CD-RW, or other physical information-storage medium. During this process, only a small portion of the content appears in decompressed and fully decrypted form, or clear form, within the memory of the consumer's computer or other data-processing appliance. Otherwise, the content is compressed and well protected by one or more layers of encryption. It is thus exceedingly difficult, and perhaps impossible, for a malicious or dishonest user to intercept and re-assemble the content into an illegal copy. The content can be further protected on the physical CD, or other such physical information-storage medium that can be written via an input/output (“I/O”) device interconnected with the consumer's computer, using a wide variety of theft-prevention and copy-protection schemes that can be applied at various times during transfer of the content to the physical medium.

### BRIEF DESCRIPTION OF THE DRAWINGS

FIG. 1 illustrates various stages in the path from recording music to obtaining the recorded music by a consumer.

FIG. 2 illustrates one embodiment of the present invention.

FIG. 3 is a flow-control diagram illustrating one of many different possible approaches by which a consumer, or user, accessing a server via a personal computer or other electronic appliance, is identified and authorized by the server and receives client-side software that allows the user to select, receive, and store, on a physical medium, information and content provided by the server.

FIG. 4 is a flow-control diagram illustrating the initial steps by which a client requests and receives audio content for writing to a physical audio CD.

FIG. 5 illustrates the contents of a content-description-package file.

FIG. 6 is a flow-control diagram of the routine “build a CD.”

### DETAILED DESCRIPTION OF THE INVENTION

One embodiment of the present invention relates to a method and system for transferring information and content to a user, via the Internet, other communications media, or other information-transfer media, including physical media, and embodying the transferred information and content into one of various different physical data-storage media, such as a CD, DVD, CD-ROM, or other physical data-storage medium. The information and content is transferred securely, so that the information and content originator, provider, and distributor, can ensure that the user receiving the transferred information and content may not subsequently copy the received information and content and distribute it to others. This method and system also provides a means for the consumer receiving the information and content to conveniently pay for the received information and content.

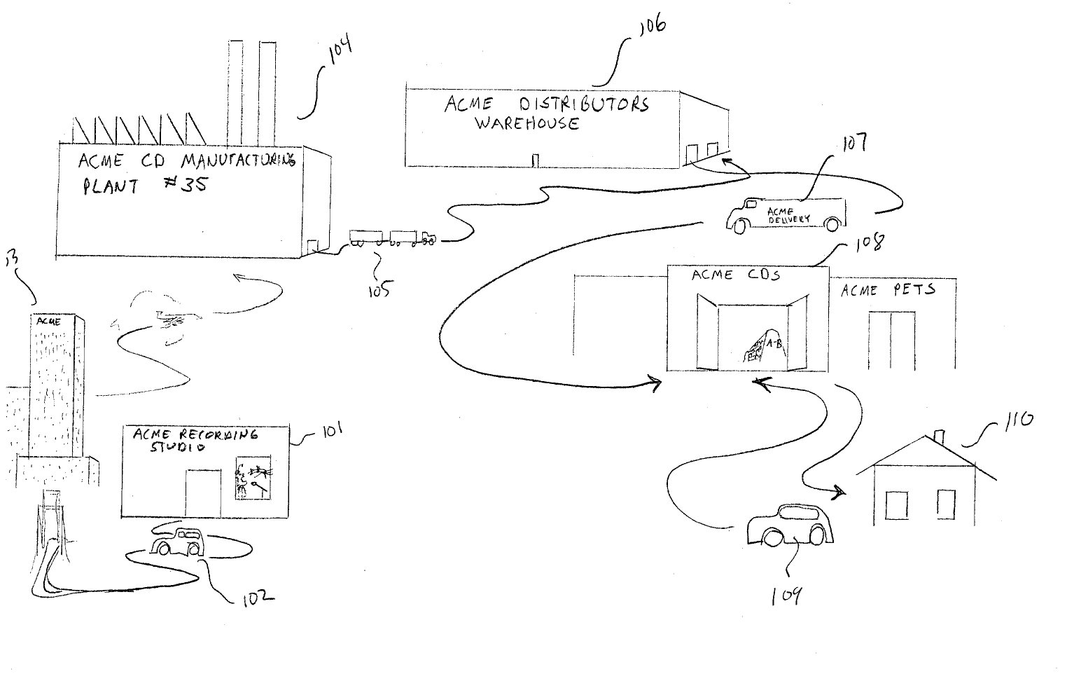

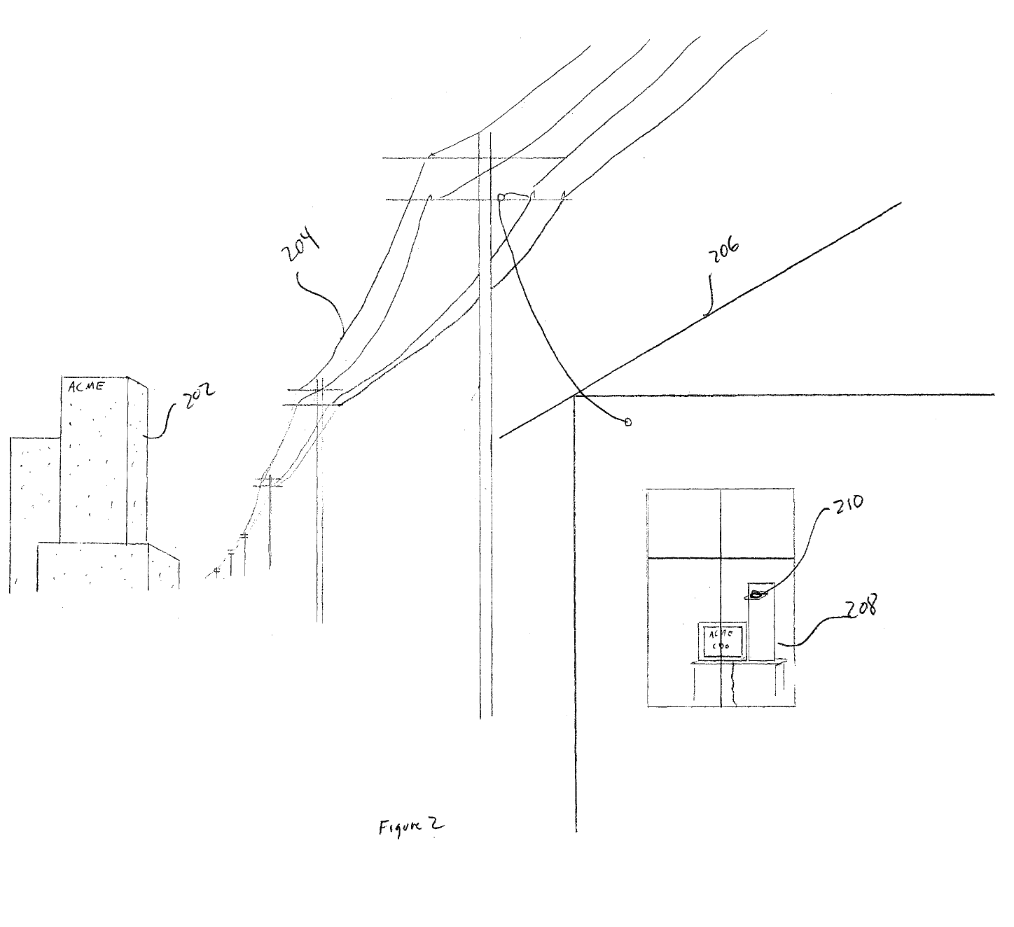

The advantages of the present invention, in the case of distributing audio content on audio CDs, is readily discerned by comparing FIG. 2 to FIG. 1, described above. FIG. 2 illustrates one embodiment of the present invention. In FIG. 2, information stored on file servers at a corporate site or distribution site 202 is electronically transferred via the Internet, represented in FIG. 2 by phone lines 204, to a consumer's residence 206. The information is received and processed by the consumer's computer 208 and written to a physical data-storage medium, such as a CD-R or CD-RW 210. Comparing FIG. 2 to FIG. 1, it is readily apparent that the present invention provides a far more direct and convenient route by which a consumer can receive a physical audio CD from a music provider. Of course, the consumer needs to purchase blank, writeable CDs, but the user may purchase many hundreds of such writeable CDs at relatively low cost in a single shopping trip or in a single Internet-mediated transaction. However, there is no longer a need for the consumer to transport himself or herself to retail outlets, there is no need for CD manufacturing facilities and distribution centers, and there is no longer a need for labor-intensive and energy-consumptive physical distribution of audio CDs. Importantly, the information and content provider is assured that the information and content is being distributed to physical, information-storage media, and not resident in clear form on consumer computers, from which the information and content could otherwise be reproduced and distributed without authorization or compensation.

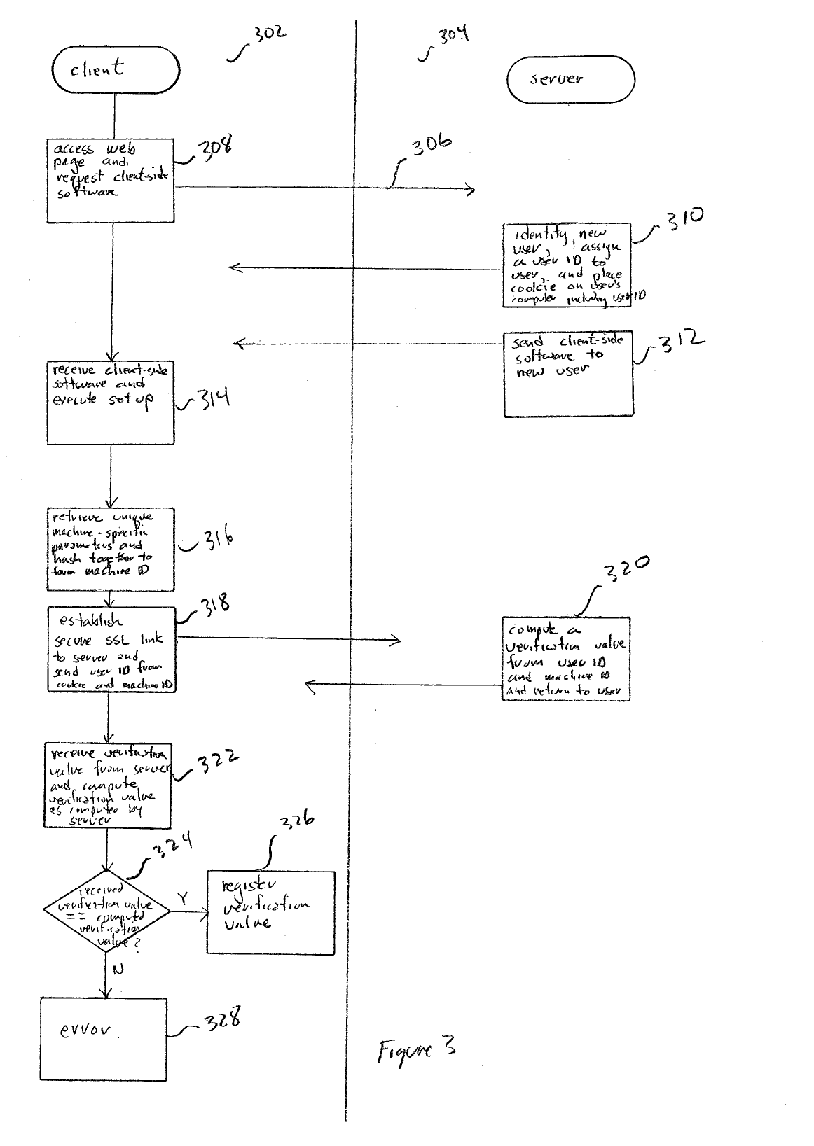

FIGS. 3-6 are flow-control diagrams and a data-structure illustration that together illustrate an audio-CD embodiment of the present invention. It should be noted that, while the present invention is discussed with respect to an audio-CD embodiment, it is not intended that the present invention be in any way restricted to a particular type of information or content transferred from an information and content provider to a consumer, nor is it intended for the present invention to be in any way restricted to a particular type of physical medium on which the information and content is permanently stored following transfer from the information and content provider to the consumer. It is anticipated that many different types of information and content can be commercially feasibly transmitted in accordance with the present invention, and that the transmitted information can be stored on many different types of currently available physical media, and will be stored on many alternative, more advanced physical data-storage medium that will become available in the future.

FIG. 3 is a flow-control diagram illustrating one of many different possible approaches by which a consumer, or user, accessing a server via a personal computer or other electronic appliance, is identified and authorized by the server and receives client-side software that allows the user to select, receive, and store, on a physical medium, information and content provided by the server. Note that in the discussion that follows, the combination of one or more users and a personal computer or other such computing appliance is often collectively referred to as a “client.” At times, when the computer portion of a client is emphasized, the term “client computer” is employed. In FIG. 3, the left portion of the diagram 302 corresponds to events and activities occurring on the client, while the right-hand portion of the diagram 304 corresponds to events and activities that occur on a server. Note that the term “server” is meant to indicate a single server, or a collection of servers and other computers, including database servers and other computers, that together provide a server interface to clients accessing the collection of computers via the Internet. The various steps of a client side are linked together by single-headed arrows, in a traditional flow-control diagram presentation. However, the steps on the server portion of the diagram 304 are not so linked, indicating that, in general, the server simply responds to client requests. In other words, the client drives and coordinates the overall process in a step-by-step fashion, while the server generally maintains only sufficient context to respond to discrete requests from one or more clients accessing the server. In FIG. 3 and in subsequent flow-control diagrams, horizontal arrows, such as horizontal arrow 306, indicate transfer of information via the Internet.

In step 308, a user accesses a web page served by the server in order to become authorized by the server and receive client-side software from the server to enable the client to receive information and content from the server. In step 310, the server identifies the access as representing access by a new user, assigns a new user ID to the user, and places a cookie on the client computer that includes the user ID assigned by the server to the client. The server also generally provides one or more web pages during these first few steps in order to allow the user to provide information useful to the server for identifying the user and ascertaining the level and type of service that the user wishes to be authorized for accessing. Because so many different types of interactions and services may be provided in different embodiments, these details are omitted in the interest of brevity. It should also be noted that the server generally checks to make sure the client is actually a new user, and may, during this stage, undertake various verification and authorization steps to ensure that the user has a sufficiently clean credit rating and has not been prohibited from using the service because of past misdeeds or abuses. In step 312, the server sends client-side software to the new user. In step 314, the client receives the client-side software from the server, appropriately positions it in local storage, and executes a set-up routine or other initialization routine to prepare the client-side software for use.

In step 316, the set-up program retrieves a number of unique, machine-specific parameters from the client computer, such as a unique processor identifier and other values embedded in the client computer, and cryptographically hashes these machine-specific parameters together to form a machine ID. Then, in step 318, the set-up program establishes a secure socket layer (“SSL”) link to the server and transmits to the server the user ID originally stored on the client computer in a cookie by the server, as well as the computed machine ID. The server, in step 320, receives the user ID and machine ID from the client and calculates from these values a verification value via another cryptographic hash that the server then returns to the client. In step 322, the client receives the verification value from the server and independently computes a verification value locally using the same algorithm used by the server to compute the verification value. In step 324, the set-up program compares the verification value received from the server to the locally computed verification value. If the locally computed verification value equals the verification value received from the server, then the client registers in the client registry, or otherwise locally stores, the verification value, in step 326, to enable the client to subsequently transfer the verification value to the server during handshake exchanges for logins and for verifying client identity during various types of transactions. If the locally computed verification value does not equal the verification value received from the server, then an error has occurred, and the error handled in step 328. Various different error-handling strategies may be employed, including attempting to restart the authentication process of steps 316, 318, 320, and 322. The server may be notified of the error, so that the server may also take steps to resolve the problem. In any case, a failure of the compare operation shown in step 324 indicates a significant problem on either the client, the server, or both the client and the server.

Once the client-side software has been transmitted and installed on the client, the client can invoke the client-side software to interact with the server to receive audio content through the Internet and write that audio content to writeable CDs. Of course, if the audio content is merely transmitted in clear audio formats, a malicious client can easily capture the content and reproduce it, at will, depriving the content provider of revenue. One aspect of the present invention is directed to ensuring that the client cannot employ the received audio content for anything other than producing a physical audio CD on the client computer. In other words, this aspect of the present invention provides the means for a user to manufacture a physical audio CD at his or her place of work or residence, but prevents the user from otherwise using or storing the content.

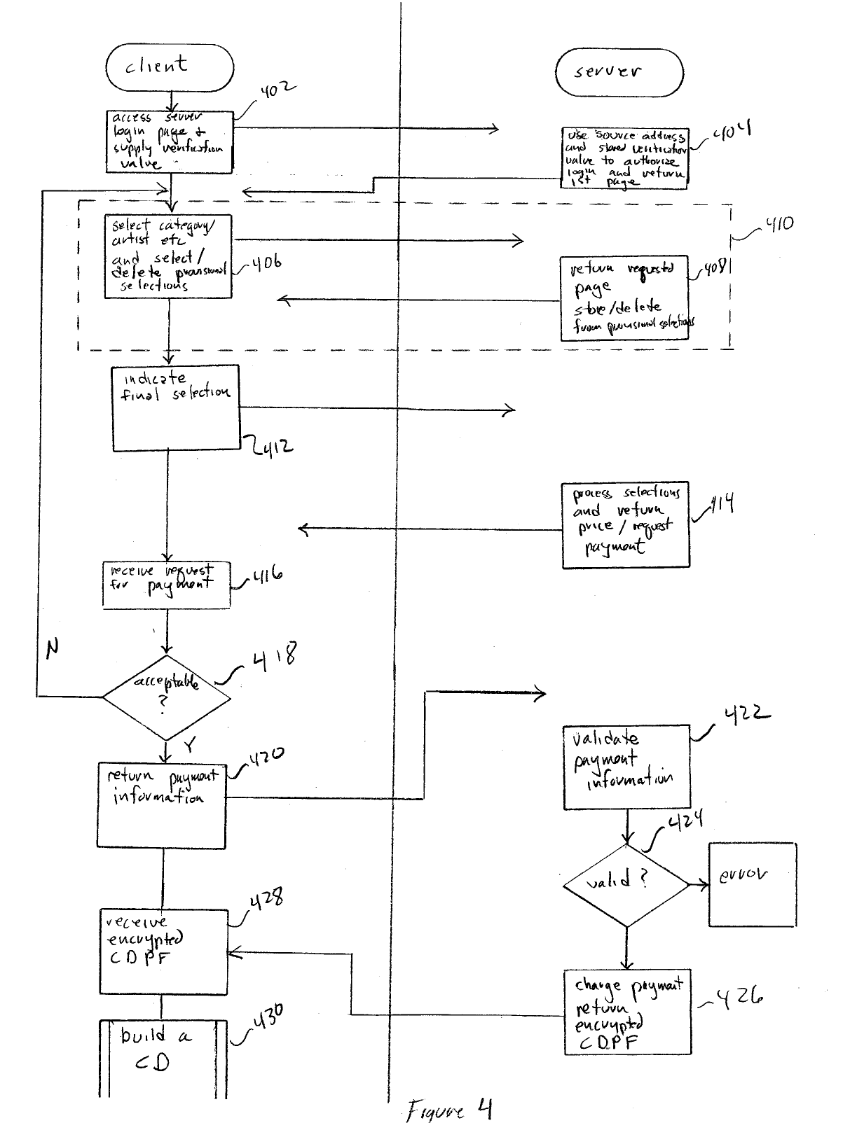

FIG. 4 is a flow-control diagram illustrating the initial steps by which a client requests and receives audio content for writing to a physical audio CD. In step 402, the client-side software accesses a server login page or other such portal and, in an initial authorization step, supplies the previously computed and stored verification value to the server. In step 404, the server receives the verification value from the client and uses the verification value, along with additional identity information identifying the client, such as the client's Internet address and alphanumeric information characterizing the client, such as the user's name and password, to authenticate the client. Assuming that the authentication succeeds, the server returns to the client a subsequent web page or other information that allows the client to begin searching and selecting audio tracks that will be subsequently combined and transferred to a writeable CD on the client computer.

In steps 406 and 408, enclosed in a dashed-line rectangle 410 to indicate that steps 406 and 408 may be repeated a number of times, the client selects a category, artist, or other more specific search criteria from the information provided by the server or, alternatively, selects or deletes provisional selections from a shopping-cart like-list of provisional selections, and returns the selections to the server. In step 408, the server processes the client's selections and either returns more specific information requested by the client or processes returned selections with respect to a list of provisional selections associated with the client. Once the client has satisfactorily chosen a list of audio tracks and other content that the client wishes to be written to an audio CD, the client, in step 412, transmits a final selection indication to the server. The server, in step 414, processes the selections remaining in the provisional selections list associated with the client and returns a price and request for payment. In step 416, the client receives the request for payment. If the terms are acceptable to the client, as determined in conditional step 418, the client, in step 420, returns payment information, such as a credit card number, to the server in order to complete the transaction. Otherwise, the client may elect to re-enter the selection process of steps 406, 408, 412, 414, and 416. When the server receives the returned payment information from the client, the server, in step 422, validates the payment information. If the payment information is valid, as determined in step 424, then the server completes the payment transaction and returns an encrypted content-description-package file (“CDPF”) to the client in step 426. The CDPF, described in greater detail below, contains sufficient information to allow the client-side software to download the audio content and write the downloaded audio content to a writeable CD on the client's computer. In addition, the client may concurrently download image and text files that allow the client to print out cover art, liner notes, and other materials that the user can assemble to produce a final audio CD comparable to an audio CD purchased at a retail outlet. In step 428, the client receives the encrypted CDPF from the server and calls the routine “build a CD” in step 430, passing the encrypted CDPF to the build-a-CD routine.

It should be noted that an almost limitless number of different alternative interaction and transaction models may be employed to allow a client to search and select audio content for writing to a CD. The example model, shown in FIG. 4, is intended only to illustrate one possible approach. There are many details of such a transaction model omitted in FIG. 4, including a number of different error detection and error handling subroutines for detecting and handling anomalies and inconsistencies that may arise during the information exchange between the client and server. In some models, a client may be able to select and specify audio content for writing to more than one CD, and may select other types of related content. In the interest of brevity, the described embodiment focuses on a process of selecting tracks for a single audio CD.

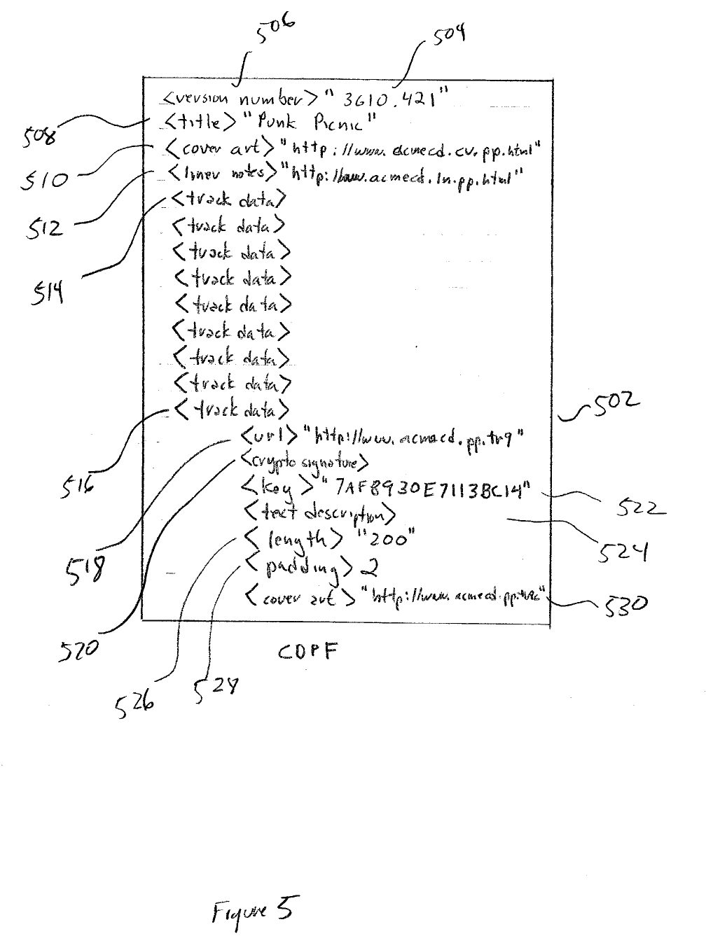

FIG. 5 illustrates the contents of a content-description-package file. It should be noted that the information contained in a CDPF may dramatically vary, depending on the type of content that is selected for transmission and writing to a CD by a client, and may vary depending on the type of content-selection and transaction models supported by the server. Example CDPF shown in FIG. 5 is intended to illustrate one possible embodiment of a CDPF related to the described audio-CD embodiment.

The example CDPF 502 shown in FIG. 5 is an extensible hypertext markup language (“XML”) document containing data associated with XML tags. The first piece of information stored in the CDPF 502 is a version number 504 associated with the tag “<version number>” 506. The version number may be used by the client-side software to determine whether or not the client-side software is of a sufficiently recent version to handle the returned CDPF. The version number may also allow the client-side software to select appropriate routines for processing the returned CDPF. The CDPF also includes a title for the audio CD to be produced 508, a uniform resource locator (“URL”) describing the file served by the server that contains the cover art for the CD 510 that may be printed out to a client printing device, and a URL describing the location of textual information corresponding to liner notes for the CD 512. Next, the CDPF includes a sequence of track-data objects, such as track-data object 514. Each track-data object describes a particular audio track to be included in the audio CD to be produced by the client computer. The final track-data object 516 is expanded, in FIG. 5, to show the information included in each track-data object. The track-data object includes a URL for the audio content corresponding to the track 518, a digital signature 520, a symmetric encryption key 522, a text description of the track 524, a length of the track, in seconds 526, the length, in seconds, of any padding that precedes the track 528, and the URL, or file specification, of cover art or other descriptive information specific to the track 530. The non-audio CD content, such as cover art, may be displayed on the client as the CD is being written. Alternatively, the non-audio content may be printed or otherwise processed by the client to supplement the audio CD. As noted above, many additional types of fields and objects may be included in the CDPF. For example, additional sessions that describe information for enhanced CDs may be included. In the case of non-audio information, entirely different CDPF formats may be employed for describing non-audio content.

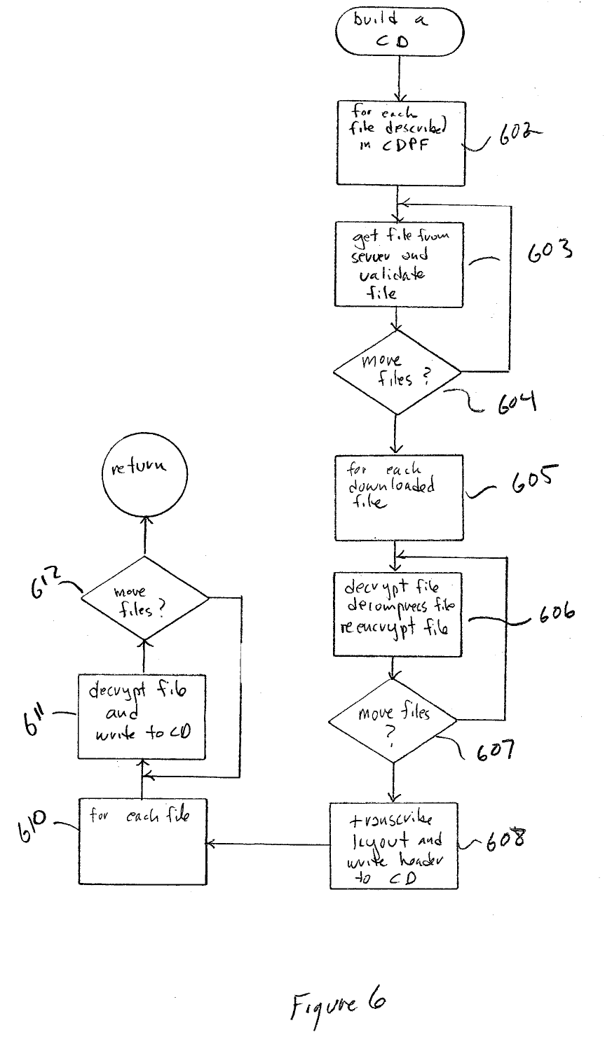

FIG. 6 is a high-level flow-control diagram of the routine “build a CD.” Steps 602-604 represent a for-loop in which each file, or other information package or information object, described in the CDPF passed to the routine “build a CD” is obtained by the client from the server and validated. Steps 605-607 represent afor-loop in which each file obtained by the client from the server in the for-loop of steps 602-604 is decrypted, decompressed, and then re-encrypted to produce a memory-resident pre-image of the audio content to be written to the CD. In step 608, the routine “build a CD” processes layout and sequencing information within the CDPF and writes a header to the CD that describes the layout of subsequent audio content on the CD. Finally, steps 610-612 represent a for-loop in which encrypted files within the memory-resident audio-content pre-image are piecewise decrypted and written to the CD to produce the final, complete audio CD. Note that, during each phase of the build-a-CD routine, at most only a very small portion of the audio content received from the server is resident in clear form within the memory of the client computer. Clear audio content is never stored in non-volatile storage. Various handshaking and validation procedures ensure that the audio content received by the client is transmitted faithfully by the server. Thus, the present invention ensures that the audio content transmitted from the server is never exposed to theft and reproduction by a malicious client.

A more detailed pseudocode representation of the routine “build a CD” follows. This C++-like pseudocode description is intended to alternatively, and more specifically, describe the build-a-CD routine illustrated in FIG. 6. First, on line 1, the client receives the encrypted CDPF from the server via a call to the function “downloadRetrieve:”

1 EncryptedCDPF=downloadRetrieve(CDPFlocation);

Next, a pointer “fileQueue” is initialized on line 2. The pointer “fileQueue” points to a memory location at which the next compressed and encrypted file obtained from the server is stored. In the do-while-loop of lines 3-15, the client decrypts a portion of the encrypted CDPF describing the next file and downloads the described file, validates the downloaded file, and updates the pointer “fileQueue” to prepare for downloading of the next audio file. Note that the client employs a cryptographic key “CDPFKey,” computed from the user ID stored in a cookie on the client and the machine ID produced by cryptographic hash of client-computer parameters, that is stored in memory on the client for decrypting portions of the CDPF. This ensures that only the client-side software, and not other routines invoked on the client, can access the CDPF in order to obtain information about the audio content. On line 5, the client downloads the next file via a call to the function “getFile,” which takes two arguments: (1) a description of the file location; and (2) a pointer to the memory location at which the file is to be downloaded. In order to obtain the description of the file used as the first argument, the function “decryptPortion” is invoked to decrypt the description of the next file within the CDPF. The function “decryptPortion” is passed a pointer to the encrypted CDPF, a file-list object, and the CDPFKey. On line 9, the function “validateFile” is called to employ a symmetric cryptographic key included in the CDPF to validate the received file. On line 12, the pointer “fileQueue” is updated.

| | |
|---|---|
| 2 | *fileQueue=START_POINT; |
| 3 | do |
| 4 | { |

| | |
|---|---|
| 5 | getFile(decryptPortion(EncryptedCDPF |

| | |
|---|---|
| 6 | fileList.fileLocation(fileQueue), |
| 7 | CDPFKey), |

| | |
|---|---|
| 8 | fileQueue); |

| | |
|---|---|
| 9 | validateFile(decryptPortion(EncryptedCDPF, |

| | |
|---|---|
| 10 | fileList.validationChecksum(fileQueue), |
| 11 | CDPFKey); |

| | |
|---|---|
| 12 | *fileQueue=(decryptPortion(EncryptedCDPF |

| | |
|---|---|
| 13 | fileList.nextFileQueue(fileQueue), CDPFKey)); |

| | |
|---|---|
| 14 | } |
| 15 | while (*fileQueue!=END_POINT) |

Next, the routine “build a CD” computes the key “InstanceKey,” a 256-bit symmetric cryptographic key, from various unique parameters, including the machine ID, user ID, and parameters characterizing the audio-CD transaction. The key “InstanceKey” is stored only in memory, and is used for re-encypting decrypted audio content for storage in memory. In the do-while-loop of lines 18-32, each of the files downloaded in the previous do-while-loop is decompressed, decrypted, and re-encrypted in order to produce a memory-resident pre-image of the audio content. Recall that the downloaded files are both compressed and encrypted to ensure efficient transfer and to ensure that the audio content cannot be captured and reproduced by a malicious user. The downloaded files are stored on the hard drive of the client. In the do-while-loop of lines 18-32, the files are decompressed and decrypted, using the symmetric encryption key for the file transmitted in the CDPF and then re-encrypted using the InstanceKey symmetric encryption key so that the audio content remains securely encrypted in its in-memory form. Although not shown in the pseudocode, the encrypted and compressed files stored on the hard disk may be removed following decompression, decryption, and re-encryption.

| | |
|---|---|
| 16 | InstanceKey=KeyGen(256, MachineID, AlbumID, PurchaseTime, UserID); |
| 17 | *fileQueue=START_POINT; |
| 18 | do |
| 19 | { |

| | |
|---|---|
| 20 | writeFile( |

| | |
|---|---|
| 21 | encryptPortion(localFileUncompressed, fileQueue, BUFFERSIZE, |

| | |
|---|---|
| 22 | decompressPortion( |
| 23 | decryptPortion(localFile, fileQueue, BUFFERSIZE, |

| | |
|---|---|
| 24 | fileList. Key(fileQueue) |

| | |
|---|---|
| 25 | ) |
| 26 | BUFFERSIZE, codec |
| 27 | ) |
| 28 | ), |

| | |
|---|---|
| 29 | InstanceKey); |

| | |
|---|---|
| 30 | *fileQueue=(decryptPortion(EncryptedCDPF, fileList.next(), CDPFKey); |

| | |
|---|---|
| 31 | } |
| 32 | while (*fileQueue!=END_POINT) |

Next, the routine “build a CD” invokes the routine “transcribeLayout,” on line 33, to gather layout details from the CDPF and write a header to the audio CD as a first step in transferring the audio content to the audio CD.

33 transcribeLayout(decryptPortion(EncryptedCDPF, LayoutDetails, CDPFKey));

Finally, in the do-while-loop of lines 35-40, the downloaded files are accessed, according to the layout created in the call to “transcribeLayout” on line 28, piecewise decrypted and written to the audio CD. In the piecewise decryption, the symmetric cryptographic key “InstanceKey” is used to decrypt only a small portion of each audio-content file at a time, so that only a very small amount of clear audio content is ever resident within memory at a given instance in time.

| | |
|---|---|
| 34 | *fileQueue=START_POINT; |
| 35 | do |
| 36 | { |

| | |
|---|---|
| 37 | transcribeFile(localFileUncompressed, BUFFERSIZE, Instancekey); |
| 38 | *fileQueue(decryptPortion(EncryptedCDPF fileList. next(), CDPFKey); |

| | |
|---|---|
| 39 | } |
| 40 | while (*fileQueue!=END_POINT) |

Although the present invention has been described in terms of a particular embodiment, it is not intended that the invention be limited to this embodiment. Modifications within the spirit of the invention will be apparent to those skilled in the art. For example, to thwart attempts to capture information as it is passed to device drivers and I/O devices, trusted device drivers and I/O devices that include security chips may be employed. As noted above, an almost limitless number of different types of information and physical information-storage media may be employed to allow a user to download information and produce physical copies without exposing the content-provider to the risks of unauthorized copying and piracy. Information distributed by embodiments of the present invention may include audio files, video files, computer software, text-based literature, multi-media files, and images. There are an almost limitless number of ways to implement the server and client-side software to produce alternative embodiments of the present invention. Additional information-securing technologies can be applied to prevent unauthorized copying of the physical information-storage medium produced by embodiments of the present invention, and these technologies may need additional information to be passed in the CDPF. Many different techniques may be applied to further obscure and camouflage the pre-image, memory-resident information and various sensitive cryptographic keys and clear portions of information files. For example, the pre-image may be fragmented and the fragments dispersed through memory.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for distributing information to a consumer through an electronic communications medium, the method comprising:
receiving a request for information-provision from the consumer;
generating a user identifier to identify the consumer;
transmitting the user identifier to the consumer's computer;
downloading client-side software onto the consumer's computer; and
upon receiving a subsequent request for information from the consumer, authenticating the user;
transmitting an encrypted description of the requested information to the consumer; and
receiving requests from the client-side software running on the consumer's computer for one or more encrypted and compressed information objects described in the encrypted description; and
securely transmitting the one or more encrypted and compressed information objects to the consumer's computer for secure writing to a physical, removeable information-storage medium.

2. The method of claim 1 wherein transmitting the user identifier to the consumer's computer further includes storing the user identifier in a cookie on the consumer's computer.

3. The method of claim 1 further including, following downloading client-side software onto the consumer's computer:
invoking an initialization routine by the user to initialize the client-side software;
collecting, by the initialization routine, unique values stored within components of the consumer's computer, and cryptographically hashing those values to produce a machine identifier; and
transmitting the machine identifier and the user identifier from the consumer's computer to the server.

4. The method of claim 3 further including:
receiving by the server the machine identifier and the user identifier;
computing a verification value from the machine identifier and user identifier; and
returning the verification value to the consumer's computer.

5. The method of claim 4 further including:
computing, by the initialization routine, a local verification value;
comparing the local verification value, by the initialization routine, to the verification value returned to the initialization routine by the server; and
detecting that an error condition has arisen if the local verification value is not equal to the verification value returned to the initialization routine by the server.

6. The method of claim 4 wherein authenticating the user upon receiving a subsequent request for information from the consumer further includes comparing a verification value and user idea transmitted to the server by client-side software running on the consumer's computer to a user identifier and verification value stored locally by the server.

7. The method of claim 1 wherein the encrypted description of the requested information transmitted to the consumer includes:
descriptions of the locations of encrypted and compressed information objects; and
layout information that maps placement of information objects onto the physical, removable information-storage medium.

8. The method of claim 1 wherein securely transmitting the one or more encrypted and compressed information objects to the consumer's computer for secure writing to a physical, removable information-storage medium further includes:
receiving the one or more encrypted and compressed information objects by the client-side software running on the consumer's computer;
generating, by the client-side software running on the consumer's computer, a local encryption key;
for each received encrypted and compressed information object,
decompressing and decrypting the encrypted and compressed information object using a cryptographic key associated with the information object in the encrypted description of the requested information,
re-encrypting the decompressed and decrypted information object and moving the re-encrypted information object into a memory-resident image; and
piecewise decrypting information objects within the memory-resident image and storing the decrypted information objects onto the physical, removable information-storage medium.

9. The method of claim 1 wherein the physical, removable information-storage medium is one of:
a CD-R;
a CD-RW;
a writeable DVD; and
a flash-memory within a secure electronic device.

10. The method of claim 1 wherein distributing information includes:
audio files;
video files;
computer software;
text-based literature;
multi-media files; and
images.

11. A physical, removable information-storage medium containing information distributed by the method of claim 1.

12. Computer instructions encoded in a computer-readable medium for the client-side software of claim 1.

13. Computer instructions encoded in a computer-readable medium that carry out the method of claim 1.

14. An encrypted description of the requested information of claim 1 stored in a computer readable memory.

15. A consumer computer containing a client-side software program that:
requests compressed and encrypted information objects from a server;
securely assembles compressed and encrypted information objects from the server into an encrypted memory-resident image; and
piecewise decrypts and writes the information objects to a physical, removable information-storage medium.
